(19) United States
(12) Patent Application Publication
(10) Pub. No.: US 2004/0085180 A1
(43) Pub. Date: May 6, 2004

(54) Current sensor, its production substrate, and its production process

(75) Inventor: Horng-Yih Juang, Hsin-Chu (TW)

Correspondence Address: BRUCE H. TROXELL, SUITE 1404, 5205 LEESBURG PIKE, FALLS CHURCH, VA, 22041, US

(73) Assignee: CYNTEC CO., LTD.

(21) Appl. No.: 10/283,052

(22) Filed: Oct. 30, 2002

(51) Int. Cl. H01C 7/10

(52) U.S. Cl. 338/20

(57) ABSTRACT

A new current sensor, its production substrate, and its production process, wherein the surface layer of the substrate is made of the thin film of low temperature coefficient of resistivity such as nickel-copper alloy, manganese-copper alloy or nickel-chromium alloy, it is tightly adhered onto the thin plates of ceramic, aluminum oxide, aluminum nitride or Beryllium dioxide (BeO) to form a new substrate by a hot-press laminating; next, by optical mask etching, the pattern of current sensor are formed on the surface of the substrate; and the flip-chip is formed on the lateral electrodes in the bottom of the current sensor unit, and the front electrodes are plated to increase the thickness; then, the pattern are modified with laser to obtain the pattern of sensor with precise and constant resistivity; after that, and the pattern of a sensor are coated with a protection layer; and the substrate is segmented, and is plated on the end face electrode 60 by sputtering; finally, a single and small chip-scaled current sensor is obtained by dicing and barrel plating.

### BACKGROUND OF THE INVENTION

1. Field of the Invention

The present invention relates to a new current sensor, its production substrate and its production process, especially to a current sensor of which a substrate surface is made of the thin films of low temperature coefficient of resistivity such as manganese-copper alloy, nickel-copper alloy or nickel-chromium alloy, to be formed into a substrate by hot-press laminating, and then the substrate is processed to form current sensors.

2. Description of the Prior Art

For the coming of the electronic-society, a current sensor, especially a chip-scaled current sensor is employed more and more generally. And because light mass and small size becomes a trend, the demand of current sensor chip with precise and good heat dissipation is increasing rapidly. It becomes an important topic how to produce the chip with rapid and efficient production process.

FIG. 1 is a perspective view of the embodiment of a conventional SMD (Surface Mounting Device) current sensor; a current sensor such as the passive element of capacitor bus and resistor bus, many of them are firmly fixed onto the motherboard 100 by SMD (Surface Mounting Device); and the substrate 200 for producing current sensors of SMD (Surface Mounting Device) or other types, is a plate made of ceramics, on which the surface is coated with the conductive material by several methods; for example, 1. Printing and firing: a ceramic thin plate is printed with a conductive material 300, such that the surface of said ceramic substrate 200 is covered with said conductive material. 2. Sputtering: a ceramic plate is coated with a layer of thin film with Ni—Cu (nickel-copper alloy) layer 300 or Ni—Cr (nickel-chromium alloy) layer by sputtering machine. And then, proceed segmenting and other production processes, of current sensors such as IC and CPU.

The above-mentioned current sensor substrate made by the printing or sputtering, has a certain function but is still insufficient in practical uses: This is because: 1. The materials for printing and firing consist of glass, which increase the TCR of the final products. 2. The pure alloy can be obtained by sputtering but high vacuum and long processing time will result in too high production cost.

In view of the above-mentioned disadvantages in a conventional substrate used to produce current sensors, a new current sensor and its production process of the present invention is created after being tested and improved repeatedly by the inventor of the present invention.

### SUMMARY OF THE INVENTION

Consequently, the present invention is to provide a new current sensor, its production substrate and its production process, of which a substrate having conductive material of thin film on the surface of a ceramic thin plate is formed by the hot-press laminating at first, and such a substrate used to make current sensors would shorten the production process and then the production cost of a current sensor is reduced. This is an object of the present invention.

According to the current sensor and its production process, it can increase the thickness of the electrodes of the current sensor, such that it is favorable in heat radiation and measuring of the current sensor. This is another object of the present invention.

According to the current sensor and its production process, the electrodes can be made into a surface mounting device (SMD), such that it can be used more conveniently. This is also another object of the present invention.

A more complete understanding of these and other features and advantages of the present invention will be apparent from a careful consideration of the following detailed description of certain embodiments illustrated in the accompanying drawings.

### BRIEF DESCRIPTION OF THE DRAWINGS

FIG. 1 is a perspective view of the embodiment of the conventional current sensor having the structure of SMD (Surface Mounting Device).

FIG. 2 is a perspective view of the structure of the substrate and the production of the current sensor as shown in FIG. 1.

FIGS. 3A to 3G are the flow charts of the production processes of the new current sensor of the present invention.

FIG. 4 is a cross-sectional view of the structure of the new current sensor of the present invention.

### DETAILED DESCRIPTION OF THE PREFERRED EMBODIMENT

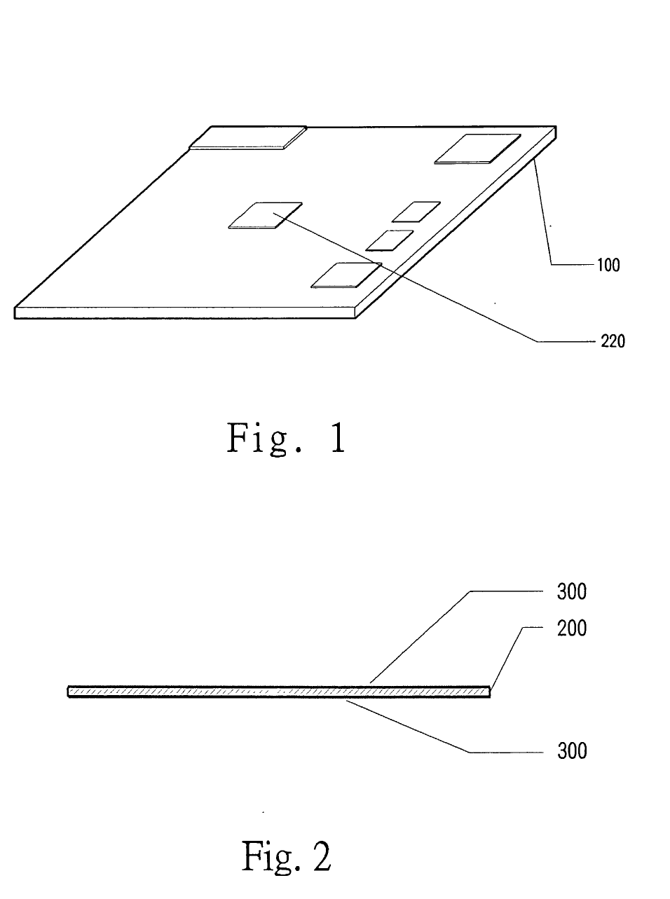

FIG. 1 and FIG. 2 are the perspective views of the embodiment of the conventional current sensors having the structure of SMD (Surface Mounting Device); and, its functions, disadvantages and production are mentioned above, it is not repeated here with.

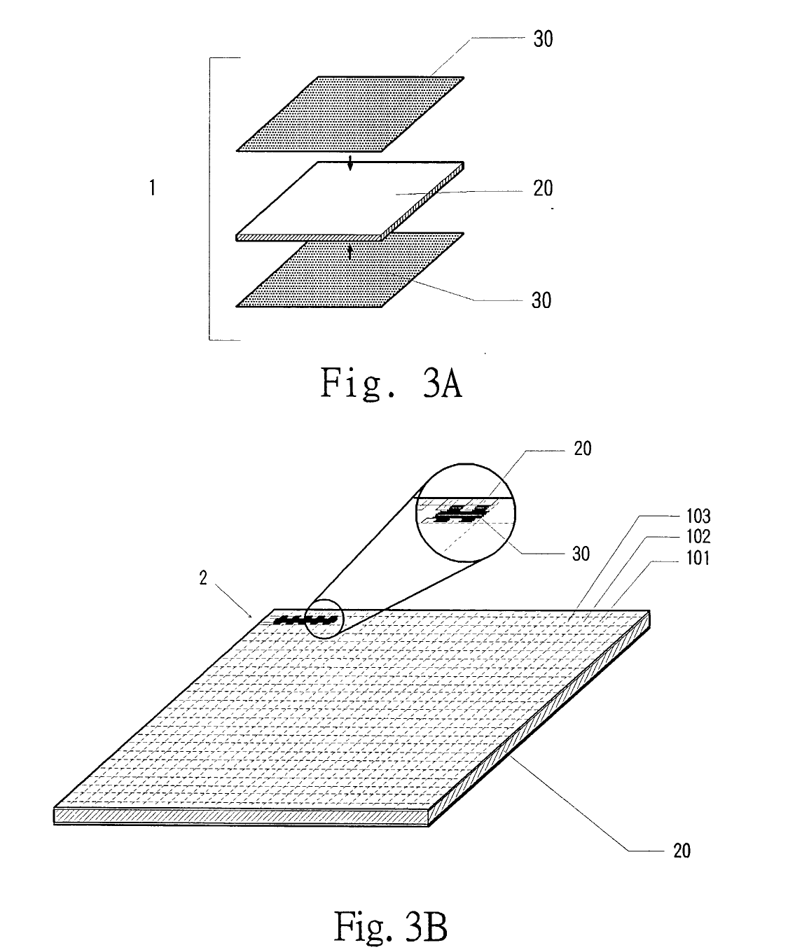

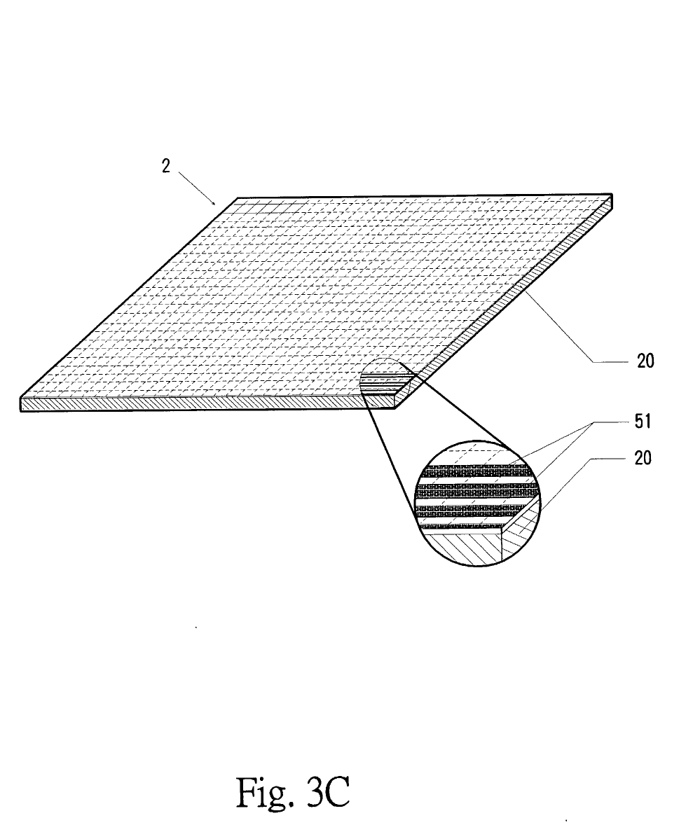

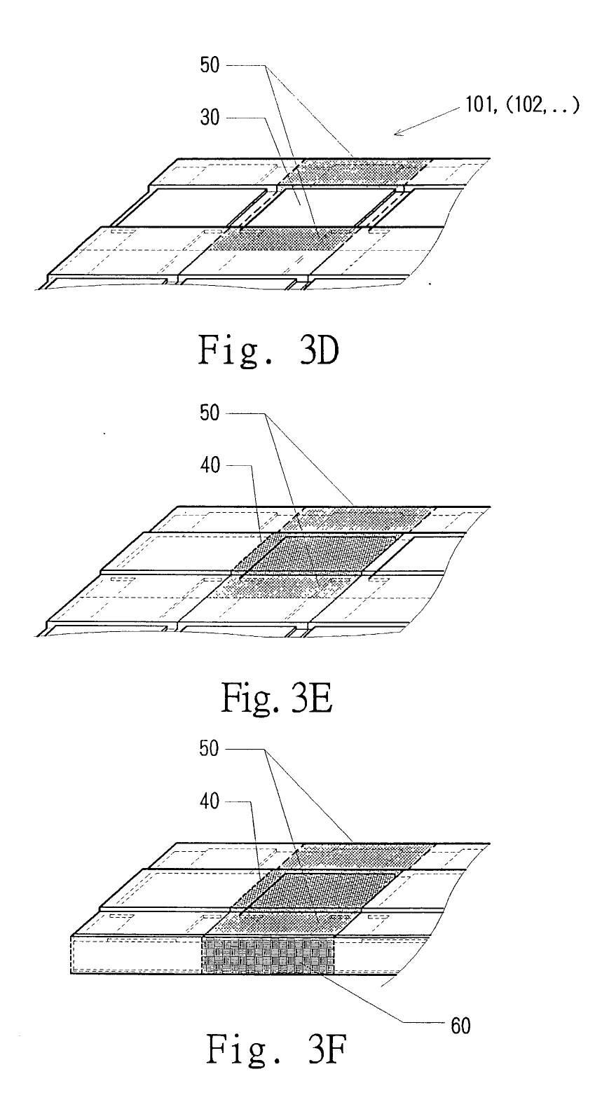

FIGS. 3A to 3F are the flow charts of the production process of a new current sensor of the present invention. In the production process, as shown in FIG. 3A, firstly, a ceramic thin plate 20 is used as the middle material, and its upper and bottom surfaces are attached with the conductive thin film 30 having lower temperature coefficient of resistivity (TCR) to form a current sensor; the conductive thin film 30 is preferably a thin film made of nickel-copper (Ni—Cu) alloy, manganese-copper (Mn—Cu) alloy, or nickel-chromium (Ni—Cr) alloy etc.; the material of the ceramic thin plate may be aluminum oxide, aluminum nitride, berium oxide(BeO).

After the middle material of ceramic thin plate 20 and a thin film 30 made of the same conductive material of alloy are formed respectively, the same alloy thin films 30 having same conductive features are hot-press laminated onto the ceramic plate 20 by a hot-press machine, and then, the substrate of the present invention is obtained. Here, it has to be emphasized that the upper and bottom conductive thin film 30 of the ceramic thin plate 20 are the same material, so as to avoid the deformation and bend of the substrate 1.

Referring to FIG. 3B, after the above-mentioned substrate 1 is obtained, by optical mask etching, the pattern 2 of the current sensor is formed on the substrate 1.

Next, as shown in FIG. 3C, the flip-chip 51 is formed on the lateral sides in the bottom of the current sensor unit, so as to form a surface mounting device and to increase the thickness of a electrode 50.

Furthermore, as shown in FIG. 3D, the pattern of the formed current sensor is modified with laser, such as the resistivity of each current sensor 101 is precise and constant.

After that, as shown in FIG. 3E, a resin protection layer 40 is coated on the pattern of the current sensor.

And then, as shown in FIG. 3F, a substrate formed into current sensor is segmented, and the end face electrodes 60 are formed by sputtering. Finally, a single and small chip-scaled current sensor is obtained by dicing and barrel plating (as shown in FIG. 3G).

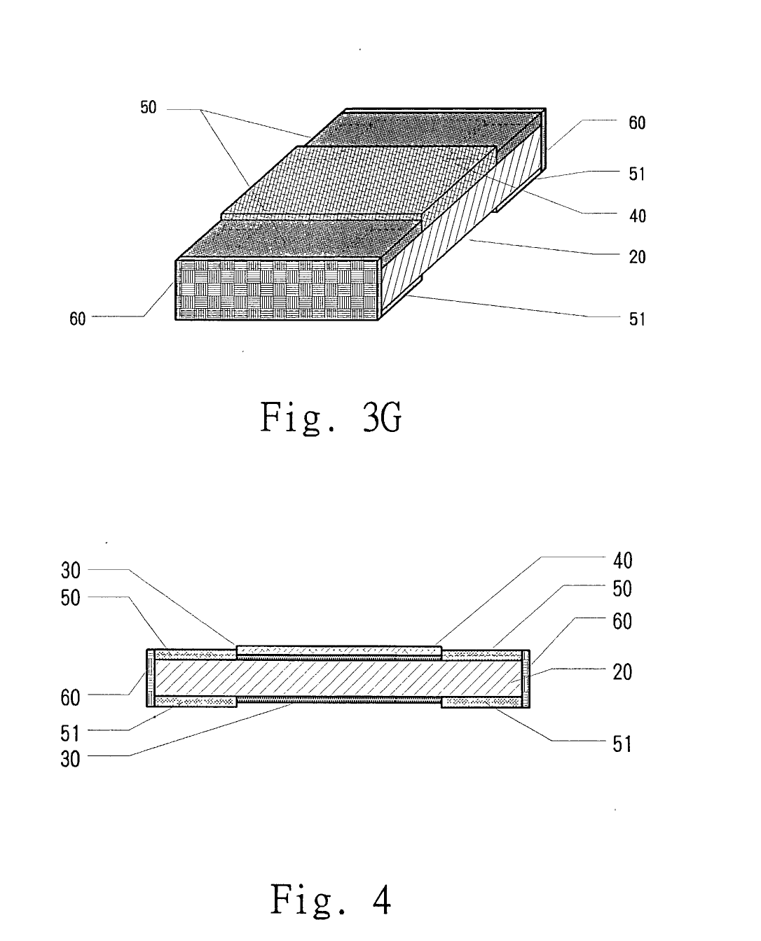

The current sensor obtained from the production process of the present invention is shown in FIG. 4, of which the surface mounting device (SMD) formed with the flip-chip 51 in the bottom, is favorable for heat radiating and measuring as a result of the increasing of thickness of the lateral electrodes.

In the production process of the present invention, the productions of a substrate and the others can be proceeded respectively in two different places. Then, the substrate can be manufactured in the substrate manufactory, and the current sensor can reduce the process of coating the conductive materials onto the ceramic plate. Therefore, the efficiency of production can be increased and the cost can be reduced.

Although the present invention has been described with a certain degree of particularity, the present disclosure has been made by way of example and change in details of structure may be made without departing from the spirit thereof.

What is claimed is:

1. A new current sensor and the production process thereof, wherein the thin film of low temperature coefficient of resistivity such as nickel-copper alloy, manganese-copper alloy or nickel-chromium alloy, is tightly adhered to a thin plate of ceramic, aluminum oxide, aluminum nitride or berium oxide (BeO) to form a new substrate by a hot-press laminating; the next, by optical mask etching, the pattern of current sensor is formed on the substrate surface; and the flip-chip is formed on the lateral electrodes in the bottom of the current sensor unit and the front electrodes are plated to increase their thickness; then, the patterns are modified with laser to obtain the patterns of sensor with precise and constant resistivity; and then, the patterns of a sensor are coated with a protection layer; and, further, the substrate is segmented, and is plated on the end face electrode 60 by sputtering; finally, a single and small chip-scaled current sensor is obtained by dicing and barrel plating.

2. The production process of a current sensor as claimed in claim 1, wherein the materials of the upper and bottom surface of a substrate are the same.

3. A new current sensor, characterized in that: the current sensor comprises a middle layer, a alloy layer attached to the bottom surface of the middle layer, a sensor conduction layer with patterns, it is attached onto surface of the middle layer, the electrode layers in the lateral sides of said sensor conduction layer, a protection layer coating on the patterns of the sensor, and the electrode layers on the surfaces in the opposite sides.

4. The current sensor as claimed in claim 3, wherein, the middle layer is made of ceramic, aluminum oxide, aluminum nitride, or Beryllium dioxide.

5. The current sensor as claimed in claim 3, wherein the materials of the bottom and the surface, of the middle layer are the same alloys with low temperature coefficient of resistivity.

6. A new production substrate of a current sensor, characterized in that: a thin film of nickel-copper alloy, manganese-copper alloy or nickel-chromium alloy, is tightly adhered to a thin plate of ceramic to form new substrate by hot-press laminating; said new production substrate of current sensor not only increases the radiativity of the substrate but also simplifies the production process of a current sensor with hot-press laminating nickel-copper alloy, manganese-copper alloy or nickel-chromium alloy on the surface of the ceramic plate.
